(19) United States
(12) Patent Application Publication
(10) Pub. No.: US 2026/0356300 A1
(43) Pub. Date: Nov. 12, 2026

(54) SWINGING PANEL SYSTEMS FOR TRUCK BEDS

(71) Applicant: Dee Zee, Inc., Des Moines, IA (US)

(72) Inventors: Bart Zylstra, Pleasant Hill, IA (US); Eric Schuling, Bondurant, IA (US)

(73) Assignee: Dee Zee, Inc., Des Moines, IA (US)

(21) Appl. No.: 19/631,375

(22) Filed: Mar. 27, 2026

Related U.S. Application Data
(60) Provisional application No. 63/781,504, filed on Apr. 1, 2025.

(51) Int. Cl. B60R 11/00; B62D 33/023

(52) U.S. Cl. CPC B60R 11/00; B62D 33/023; B60R 2011/0019; B60R 2011/0085

(57) ABSTRACT

A swinging panel system for a vehicle storage area includes a storage panel including a top edge, a bottom edge, a first edge that extends between the top and bottom edges, a second edge that extends between the top and bottom edges and a face extending between the top, bottom, first and second edges and comprising an array of openings extending therethrough forming a mesh of the openings, vertical solid support areas and horizontal solid support areas surrounding the openings. A hinge bracket includes a rear swinging portion that is configured to mount to the second edge. The rear swinging portion is pivotally connected to a front fixed portion that is configured to mount to a sidewall of the vehicle storage area such that the second edge extends in a vehicle vertical direction. A striker plate includes a striker that is configured to mount to the sidewall of the vehicle at a location forward in a vehicle longitudinal direction of the hinge bracket. A latch assembly is configured to mount to the storage panel comprises a latch arm that is configured to releasably engage the striker with the storage panel in a stowed configuration.

### CROSS REFERENCE TO RELATED APPLICATION

This application claims the benefit of and priority to U.S. Patent Application No. 63/781,504 entitled “Swinging Panel Systems for Truck Beds” filed Apr. 1, 2025, the details of which are incorporated by reference.

### TECHNICAL FIELD

The present specification generally relates to vehicle panels and, more specifically, to swinging panel systems for truck beds.

### BACKGROUND

Various storage systems for truck beds are known, such as a variety of toolbox types. Depending on where the storage systems are located inside the truck beds, it may be difficult to access the storage systems from outside the truck beds.

Accordingly, what is desired are storage systems that can be readily accessed outside the truck bed.

### SUMMARY

In accordance with one embodiment, a swinging panel system for a vehicle storage area includes a storage panel including a top edge, a bottom edge, a first edge that extends between the top and bottom edges, a second edge that extends between the top and bottom edges and a face extending between the top, bottom, first and second edges and comprising an array of openings extending therethrough forming a mesh of the openings, vertical solid support areas and horizontal solid support areas surrounding the openings. A hinge bracket includes a rear swinging portion that is configured to mount to the second edge. The rear swinging portion is pivotally connected to a front fixed portion that is configured to mount to a sidewall of the vehicle storage area such that the second edge extends in a vehicle vertical direction. A striker plate includes a striker that is configured to mount to the sidewall of the vehicle at a location forward in a vehicle longitudinal direction of the hinge bracket. A latch assembly is configured to mount to the storage panel comprises a latch arm that is configured to releasably engage the striker with the storage panel in a stowed configuration.

In accordance with another embodiment, a method of installing a swinging panel system kit in a truck bed is provided. The method includes . . . mounting a storage panel to a rear swinging portion of a hinge bracket, the storage panel comprising a top edge, a bottom edge, a first edge that extends between the top and bottom edges, a second edge that extends between the top and bottom edges and a face extending between the top, bottom, first and second edges and comprising an array of openings extending therethrough forming a mesh of the openings, vertical solid support areas and horizontal solid support areas surrounding the openings. A front fixed portion of the hinge bracket is mounted to a sidewall of the truck bed such that the second edge extends in a vehicle vertical direction. The rear swinging portion is pivotally mounted to the front fixed portion of the hinge bracket. A striker plate is mounted to the sidewall of the truck bed at a location forward in a vehicle longitudinal direction of the hinge bracket. The striker plate includes a striker configured to engage with a latch assembly carried by the storage panel.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 diagrammatically depicts a perspective rear view of a rear portion of a pickup truck including a truck bed with a swinging panel system in a stowed position, according to one or more embodiments shown and described herein;

FIG. 2 diagrammatically depicts the swinging panel system of claim 1 in a deployed configuration, according to one or more embodiments shown and described herein;

FIG. 3 diagrammatically depicts a detail view of the swinging panel system of FIG. 2 in the stowed position, according to one or more embodiments shown and described herein;

FIG. 4 diagrammatically depicts a detail view of the swinging panel system of FIG. 1 in the deployed position, according to one or more embodiments shown and described herein;

FIG. 5 diagrammatically depicts a striker plate of the swinging panel system of

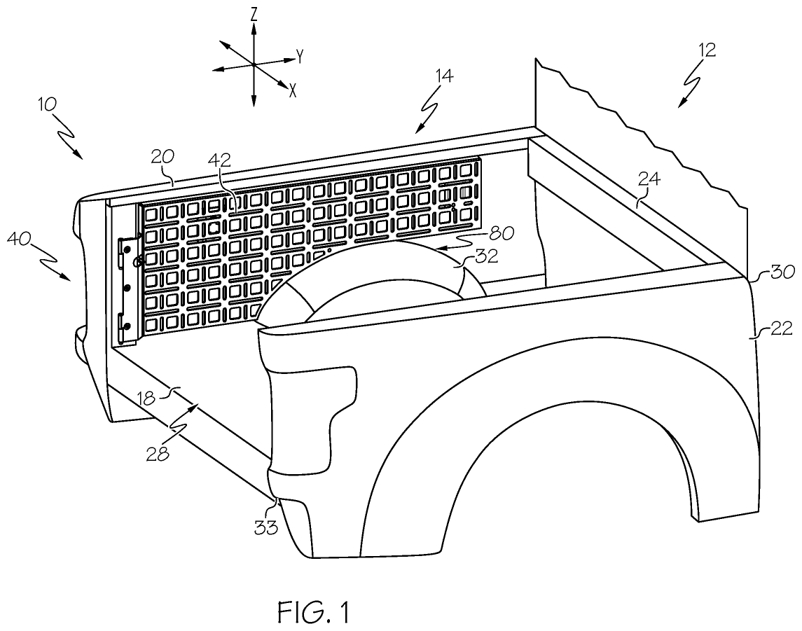

FIG. 1, according to one or more embodiments shown and described herein;

FIG. 6 diagrammatically depicts a detail view of a latch assembly of the swinging panel system of FIG. 1, according to one or more embodiments shown and described herein;

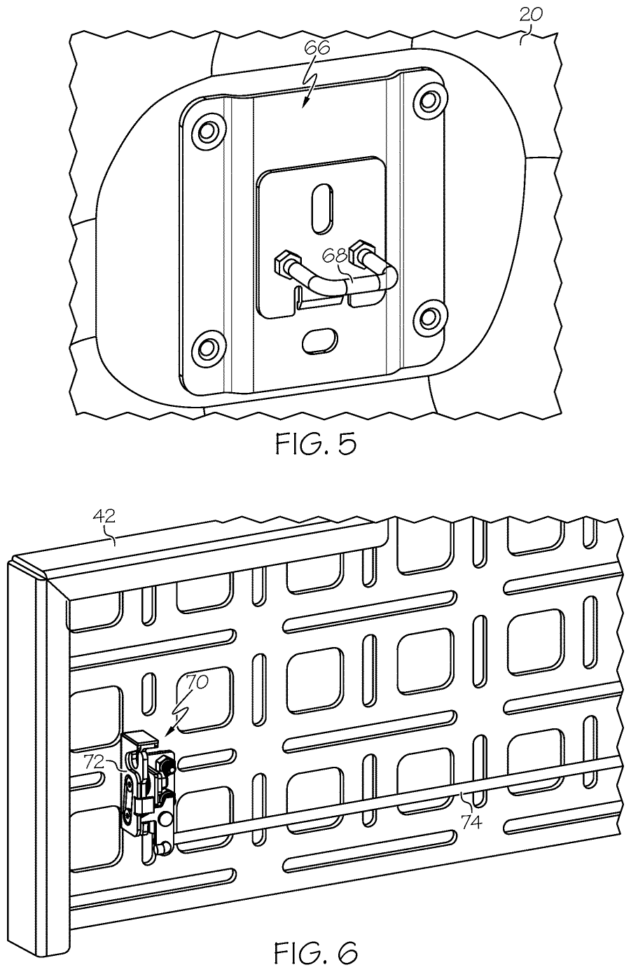

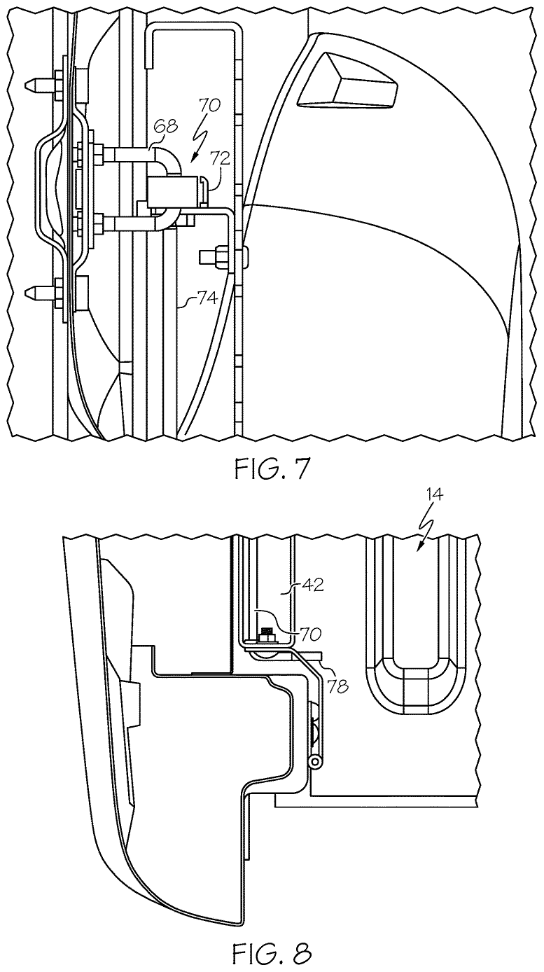

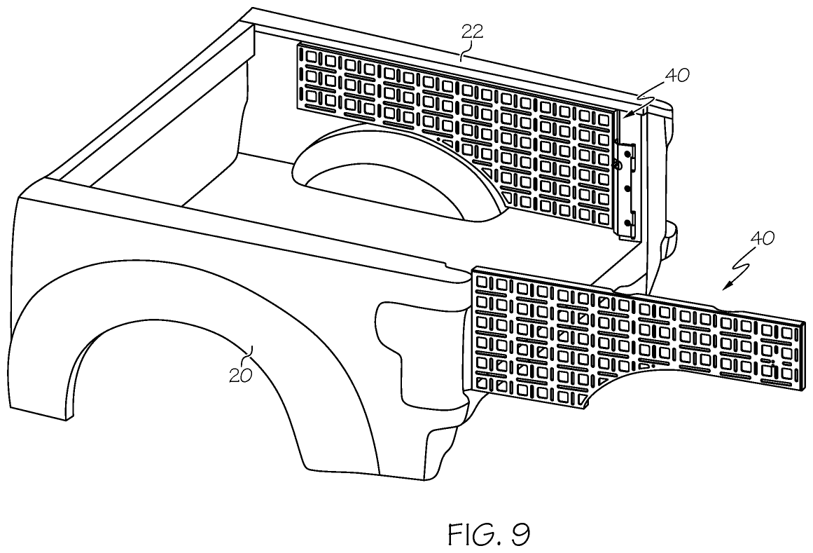

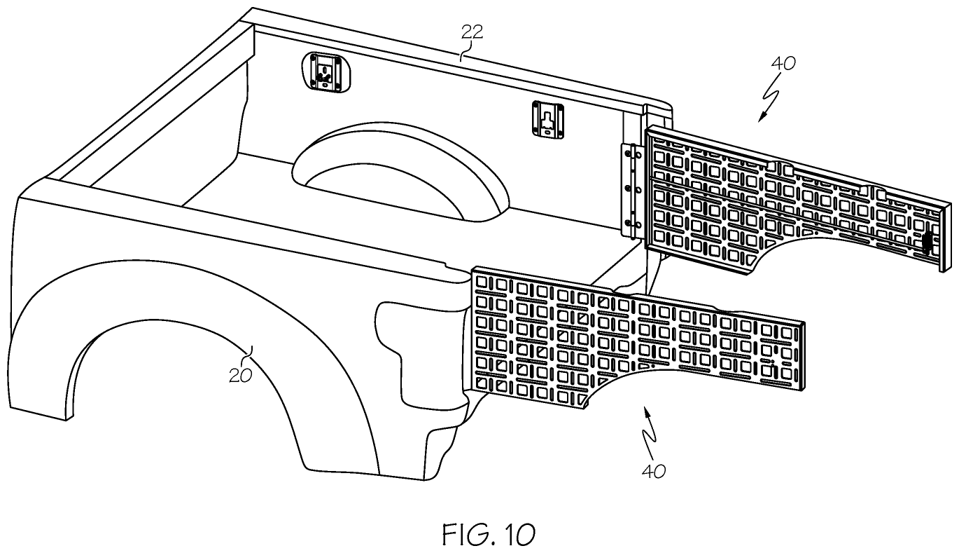

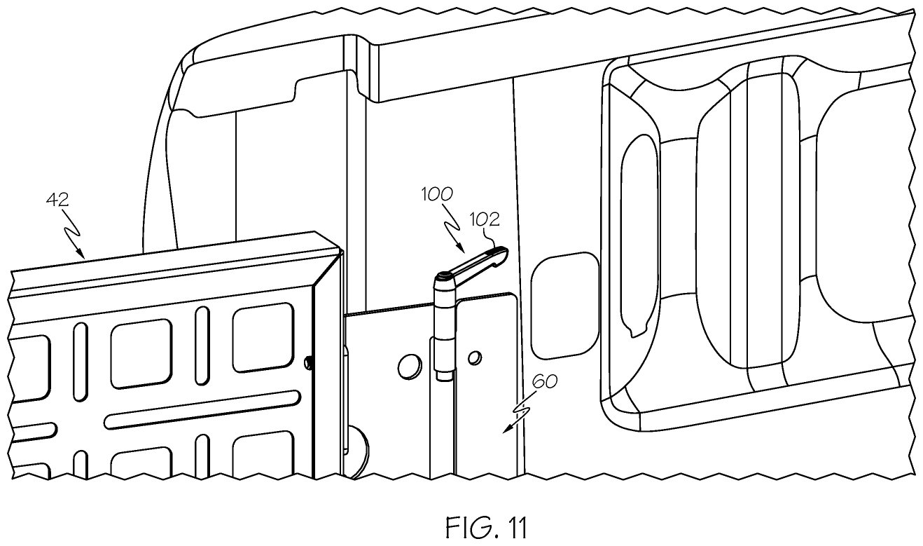

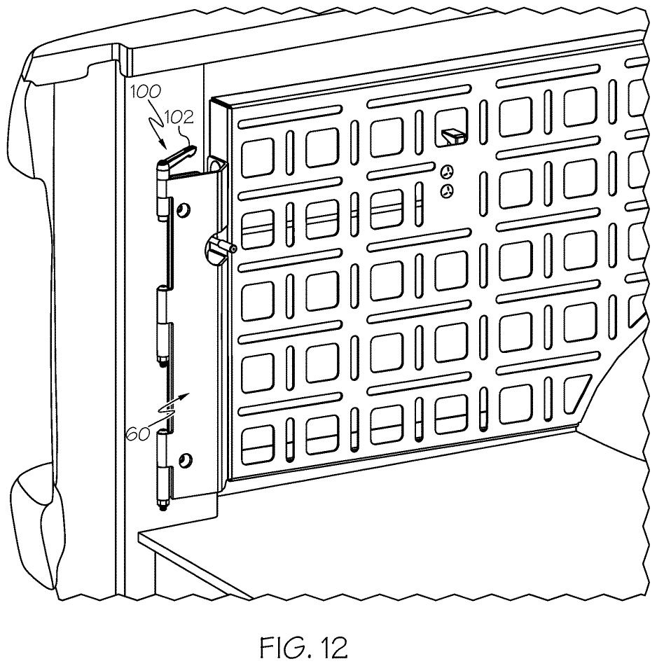

FIG. 7 diagrammatically depicts a detail, top view of the latch assembly of FIG. 6 engaged with the striker plate of FIG. 5, according to one or more embodiments shown and described herein;

FIG. 8 diagrammatically depicts a detail, top view of a handle of a release rod of the swinging panel system of FIG. 1, according to one or more embodiments shown and described herein;

FIG. 9 diagrammatically depicts an opposite side of the truck bed of FIG. 1 showing another swinging panel system in a stowed position, according to one or more embodiments shown and described herein;

FIG. 10 diagrammatically depicts a pair of swinging panel systems in deployed positions, according to one or more embodiments shown and described herein;

FIG. 11 diagrammatically depicts a portion of a swinging panel system in an open configuration that includes a lock mechanism; and

FIG. 12 diagrammatically depicts a portion of the locking panel system of FIG. 11 in a closed configuration.

### DETAILED DESCRIPTION

Swinging panel systems for a vehicle storage areas include . . . a storage panel that includes a top edge, a bottom edge, a first edge that extends between the top and bottom edges, a second edge that extends between the top and bottom edges and a face extending between the top, bottom, first and second edges. The face includes an array of openings extending therethrough that form a mesh of the openings, vertical solid support areas and horizontal solid support areas surrounding the openings (e.g., a MOLLE panel). A hinge bracket includes a rear swinging portion that is configured to mount to the second edge. The rear swinging portion is pivotally connected to a front fixed portion that is configured to mount to a sidewall of the vehicle storage area such that the second edge extends in a vehicle vertical direction. A striker plate includes a striker that is configured to mount to the sidewall of the vehicle at a location forward in a vehicle longitudinal direction of the hinge bracket. A latch assembly includes a latch arm that is configured to releasably engage the striker with the storage panel in a stowed configuration.

As used herein, the term “vehicle longitudinal direction” refers to the forward-rearward direction of the pickup truck (i.e., in the +/−vehicle Y direction depicted in FIG. 1). The term “vehicle lateral direction” refers to the cross-pickup truck direction (i.e., in the +/−vehicle X direction depicted in FIG. 1), and is transverse to the vehicle longitudinal direction. The term “vehicle vertical direction” refers to the upward-downward direction of the pickup truck (i.e., in the +/−vehicle Z-direction depicted in FIG. 1). As used herein, “upper” and “above” are defined as the positive Z direction of the coordinate axis shown in the drawings. “Lower” and “below” are defined as the negative Z direction of the coordinate axis shown in the drawings.

Referring to FIG. 1, the terms “outboard” or “outward” as used herein refers to the relative location of a component in a direction with respect to a pickup truck centerline. The term “inboard” or “inward” as used herein refers to the relative location of a component in a direction with respect to the pickup truck centerline. Because the pickup truck structures may be generally symmetrical about the pickup truck centerline, the direction to which use of terms “inboard,” “inward,” “outboard” and “outward” refer may be mirrored about the pickup truck centerline when evaluating components positioned along opposite sides of the pickup truck 10.

A pickup truck is generally illustrated at 10 with a passenger cabin 12 and a truck bed 14. The truck bed 14 includes a bed deck 18, a pair of spaced apart sidewalls 20, 22, a front wall 24, and may include a tailgate. The bed deck 18, the sidewalls 20, 22, the front wall 24, and the tailgate (not shown) define a storage area 28 of the truck bed 14.

The sidewalls 20, 22 extend parallel to the vehicle longitudinal direction. Each sidewall 20, 22 includes a front end 30 and an opposite rear end 33. The front wall 24 extends between the front ends 30 of the sidewalls 20, 22. The tailgate may extend between the rear ends 33 of the sidewalls 20, 22.

Wheel wells 32 and 34 (FIGS. 9 and 10) are located in the storage area 28 of the truck bed 14. The wheel wells 32 and 34 are the enclosures that house the rear wheels of the truck 10. As can be seen, the wheel wells 32 and 34 extend inward from the sidewalls 20 and 22 and also vertically from the bed deck 18. In this regard, the wheel wells 32 and 34 take up space within the storage area 28. The wheel wells 32 also change the footprint of the bed deck 18 by reducing a width of the bed deck 18 between the wheel wells 32 and 34.

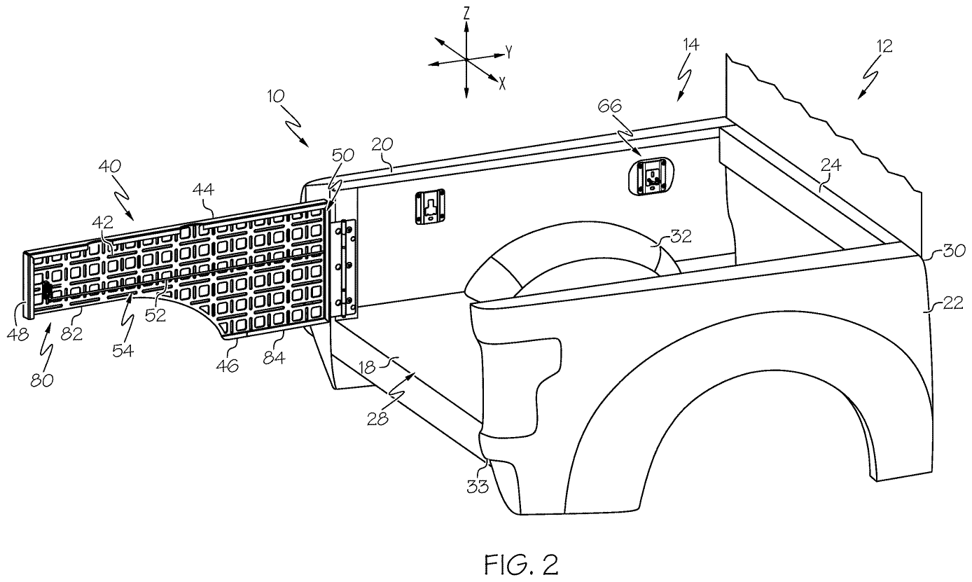

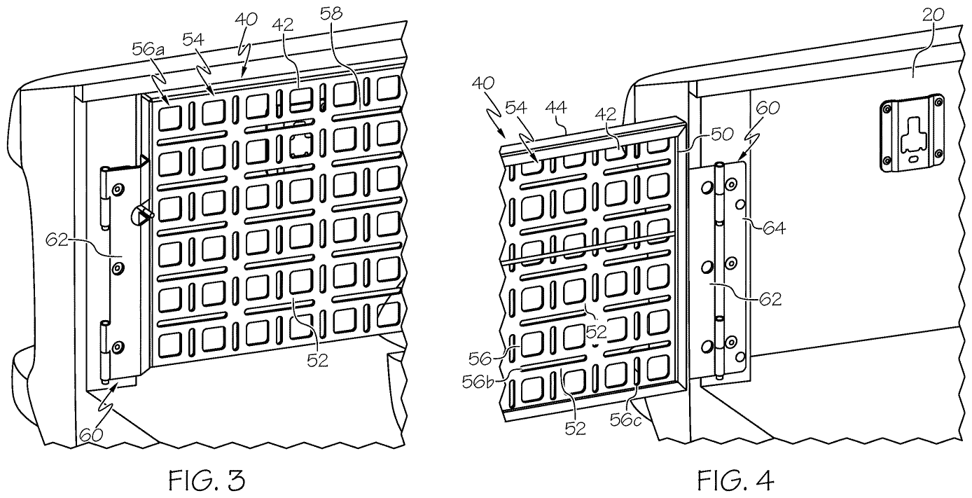

A swinging panel system 40 includes a storage panel 42 that is pivotally mounted to the sidewall 20. Referring also to FIG. 2, the storage panel 42 includes a top edge 44, a bottom edge 46, a first edge 48 that extends between the top and bottom edges 44, 46, a second edge 50 that extends between the top and bottom edges 44, 46 and a face 52 that extends between the top, bottom, first and second edges 44, 46, 48 and 50 forming a panel structure. Referring also to FIGS. 3 and 4, the face 52 can include an array of openings 54 extending therethrough that form a mesh of the openings 54, vertical solid support areas 56 and horizontal solid support areas 58 that surround the openings 54 forming a MOLLE structure. The face 52 is configured to hold cargo that is clipped or otherwise attached to the face 52 using the array of openings 54 and surrounding structure. In particular, the openings 56 may include square-shaped openings 56a, horizontally-extending slots 56b and vertically-extending shorter slots 56c. While this arrangement of openings is shown, any suitable array of openings of any suitable shapes may be used to form a MOLLE-type structure for the face.

Referring to FIGS. 3 and 4, the swinging panel system 40 includes a hinge bracket 60. The hinge bracket 60 includes a rear swinging portion 62 that is configured to mount to the second edge 50 of the storage panel 42. The rear swinging portion 62 is pivotally connected to a front fixed portion 64 that is configured to mount to the sidewall 20 of the vehicle storage area (e.g., truck bed 14) such that the second edge 50 extends in the vehicle vertical direction. Referring to FIG. 5, a striker plate 66 includes a striker 68 that is configured to mount to the sidewall 20 of the vehicle 10 at a location forward in a vehicle longitudinal direction of the hinge bracket 60. As can be seen in FIG. 2, the striker plate 66 may be mounted above or in front of the wheel well 32 such that the storage panel 42 can swing over the wheel well 32 in a stowed position shown by FIG. 1.

Referring briefly to FIGS. 11 and 12, in some embodiments, a lock mechanism 100 may be used to lock the hinge bracket 60 and storage panel 42 in the open (FIG. 11) and/or closed (FIG. 12) position. Turning a handle 102 in one direction locks the hinge bracket 60 and storage panel 42 to prevent swinging of the storage panel 42 and turning the handle 102 in the opposite direction unlocks the hinge bracket 60 and storage panel 42 to allow swinging of the storage panel 42. Such a locking arrangement can prevent unintended movement of the storage panel 42.

Referring now to FIG. 6, a latch assembly 70 configured to mount to the storage panel 42 includes a latch arm 72 that is configured to releasably engage the striker 68 with the storage panel 42 in a stowed position. As can be seen in FIG. 7, a release rod 74 may be operatively connected to the latch assembly 70 such that manually actuating the release rod 70 (e.g., pushing/pulling) can lock and release the latch arm 72 so that the latch arm can pivot to either engage the striker 68 or release the striker 68. Referring to FIG. 8, an end 78 of the release rod 70 may be accessible at the rear of the truck bed 14 with the storage panel 42 in the stowed configuration so that the user can easily access the release rod 70 and unlatch the latch assembly 70.

Referring again to FIGS. 1 and 2, because the storage panel 42 may swing over the wheel well 32, the storage panel 42 may be accordingly shaped with a cut-out region 80 that corresponds to the shape of the wheel well 32 such that the storage panel 42 can be moved against the sidewall 20 in the stowed position. At the cut-out region 80, the storage panel 42 has a reduced height dimension such that edge portion 82 is located above edge portion 84. When in the stowed position, the storage panel 42 can reduce the amount of area of the truck bed 14 that is blocked by the storage panel 42.

Referring to FIGS. 9 and 10, both sidewalls 20 and 22 may include swinging panel systems 40. The swinging panel systems 40 may operate independently, which is shown by FIGS. 9 and 10.

The above-described swinging panel systems provide a MOLLE-type storage panel for storing various cargo, such as tools, sporting gear, flashlights, etc. The storage panels have a stowed position above the wheel well and against the sidewall and a deployed configuration where the storage panels are swung rearward for providing increased access without having to enter the truck bed. In some embodiments, the swinging panel systems may be provided as a kit with instructions for assembly to a vehicle. While trucks are primarily shown, the kit may be used on any suitable vehicle, such as an SUV, ATV, etc. having a storage area.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A swinging panel system for a vehicle storage area, the swinging panel system comprising:
a storage panel including a top edge, a bottom edge, a first edge that extends between the top and bottom edges, a second edge that extends between the top and bottom edges and a face extending between the top, bottom, first and second edges and comprising an array of openings extending therethrough forming a mesh of the openings, vertical solid support areas and horizontal solid support areas surrounding the openings;
a hinge bracket comprising a rear swinging portion that is configured to mount to the second edge, the rear swinging portion pivotally connected to a front fixed portion that is configured to mount to a sidewall of the vehicle storage area such that the second edge extends in a vehicle vertical direction;
a striker plate comprising a striker configured to mount to the sidewall of the vehicle at a location forward in a vehicle longitudinal direction of the hinge bracket; and
a latch assembly configured to mount to the storage panel comprises a latch arm configured to releasably engage the striker with the storage panel in a stowed configuration.

2. The swinging panel system of claim 1, wherein the storage panel has a cut-out region providing the storage panel with a reduced height dimension at the cut-out region.

3. The swinging panel system of claim 2, wherein a shape of the cut-out region corresponds to a shape of a wheel well of a truck bed.

4. The swinging panel system of claim 3, wherein the storage panel is configured to have a stowed position located above the wheel well.

5. The swinging panel system of claim 1, wherein the openings include square-shaped openings and slots.

6. A swinging panel system kit comprising the swinging panel system of claim 1.

7. The swinging panel system kit of claim 1, wherein the swinging panel system is a first swinging panel system, the swinging panel system kit further comprising a second swinging panel system.

8. The swinging panel system kit of claim 7, wherein the second swinging panel system comprises:
a second storage panel comprising a top edge, a bottom edge, a first edge that extends between the top and bottom edges, a second edge that extends between the top and bottom edges and a face extending between the top, bottom, first and second edges and comprising an array of openings extending therethrough forming a mesh of the openings, vertical solid support areas and horizontal solid support areas surrounding the openings of the second storage panel;
a second hinge bracket comprising a rear swinging portion that is configured to mount to the second edge of the second storage panel, the rear swinging portion of the second storage panel pivotally connected to a front fixed portion of the second storage panel that is configured to mount to an opposite sidewall of the vehicle storage area such that the second edge of the second storage panel extends in the vehicle vertical direction;
a second striker plate comprising a striker configured to mount to the opposite sidewall of the vehicle at a second location forward in the vehicle longitudinal direction of the second hinge bracket; and
a second latch assembly configured to mount to the second storage panel comprises a latch arm configured to releasably engage the striker of the second striker plate with the second storage panel in a second stowed configuration.

9. The swinging panel system kit of claim 8, wherein the second storage panel has a cut-out region providing the second storage panel with a reduced height dimension at the cut-out region of the second storage panel.

10. The swinging panel system kit of claim 9, wherein a shape of the cut-out region of the second storage panel corresponds to a shape of a wheel well of a truck bed.

11. The swinging panel system kit of claim 10, wherein the second storage panel is configured to have a stowed position located above the wheel well.

12. The swinging panel system kit of claim 8, wherein the openings of the second storage panel include square-shaped openings and slots.

13. A method of installing a swinging panel system kit in a truck bed, the method comprising:
mounting a storage panel to a rear swinging portion of a hinge bracket, the storage panel comprising a top edge, a bottom edge, a first edge that extends between the top and bottom edges, a second edge that extends between the top and bottom edges and a face extending between the top, bottom, first and second edges and comprising an array of openings extending therethrough forming a mesh of the openings, vertical solid support areas and horizontal solid support areas surrounding the openings;
mounting a front fixed portion of the hinge bracket to a sidewall of the truck bed such that the second edge extends in a vehicle vertical direction, the rear swinging portion pivotally mounted to the front fixed portion of the hinge bracket; and
mounting a striker plate to the sidewall of the truck bed at a location forward in a vehicle longitudinal direction of the hinge bracket, the striker plate comprising a striker configured to engage with a latch assembly carried by the storage panel.

14. The method of claim 13 further comprising mounting the latch assembly to the storage panel.

15. The method of claim 13, wherein the storage panel has a cut-out region providing the storage panel with a reduced height dimension at the cut-out region.

16. The method of claim 15, wherein a shape of the cut-out region corresponds to a shape of a wheel well of a truck bed.

17. The method of claim 16, wherein the storage panel is configured to have a stowed position located above the wheel well.

18. The method of claim 13, wherein the openings include square-shaped openings and slots.
